(19) United States
(12) Patent Application Publication
(10) Pub. No.: US 2004/0236711 A1
(43) Pub. Date: Nov. 25, 2004

(54) System and method for automating the extraction of information contained within an engineering document

(75) Inventors: Allan Nixon, Kew (AU); Casey Mullen, Downing, PA (US)

Correspondence Address: VENABLE, BAETJER, HOWARD AND CIVILETTI, LLP, P.O. BOX 34385, WASHINGTON, DC, 20043-9998, US

(73) Assignee: BENTLEY SYSTEMS, INC., Exton, PA

(21) Appl. No.: 10/442,201

(22) Filed: May 21, 2003

(51) Int. Cl. G06F 17/00

(52) U.S. Cl. 707/1

(57) ABSTRACT

A system and method for component indexing of design file is provided. The system includes an extraction engine for extracting information about the components of the design file, a data store for storing the information, and a link module for linking the information to the design file to an entry in the data store.

### BACKGROUND OF THE INVENTION

1. Field of the Invention

The present invention relates generally to a method and system for extracting and indexing information, and more particularly to component indexing of design files.

2. Related Art

Engineering drawings represent the design of a facility and/or, the processes that are undertaken within the facility. Often, existing engineering drawings are available in electronic form—either as a scanned image of a paper document, or as a Computer Aided Design (CAD) file.

Existing engineering documents are usually managed in an electronic archive, such as an enterprise document management system (EDMS). To find design information about a component within a facility, for example, the user must search the EDMS to find the appropriate document. If the EDMS contains a large number of documents, or if the user is unsure which document contains the required information, this search may prove lengthy and frustrating.

A component is typically a uniquely identifiable item that is of value or serves a purpose within the overall facility or asset. Rather than storing and maintaining information about components in an electronic document, individual components that together form a larger asset can be managed in a central data store. When a component is represented in a document, that document often has a link back to the central data store to provide the necessary information that fully describes the component.

“Data centric” is a term commonly used in many engineering design applications today. In general, it describes the underlying approach used to store information about components that is generated during the design of the facility. Using a data centric approach allows users to more concisely locate information about components. For example, when looking to locate a shut-off valve that is represented in a particular Process and Instrumentation Diagram (P&ID), a user can browse through the central data store to find the valve, and then locate a linked P&ID. By comparison, to locate the appropriate P&ID in an EDMS, the user would first have to know what P&ID that valve is in or, alternatively, have a method for refining the search to find the P&ID. Thus, having a system in place whereby a user can quickly locate documents associated with a component within a facility can save a great amount of time, both in regular day-to-day business and in emergency situations.

Unfortunately, much of the electronic engineering drawings that exist today pre-date the use of data centric solutions, or were not created within a data centric environment. Furthermore, when engineering drawings created in a data centric environment are handed over from the engineering consultants to the owner or operator of the facility, the drawings are disconnected from the central data store and hence the advantages are lost.

Conventional solutions offer limited choices when engineering consultants and/or facility operators want to extract and store information from engineering drawings. In one proposed solution, engineering consultants hand over an entire data centric system to an owner/operator. This solution may not be feasible in projects involving an existing facility or where design work is undertaken for an expansion or upgrade to the facility. Further, data may be provided for the new/updated portion of the facility, however no data is available for much of the existing facility. In another proposed solution, users manually enter data regarding the design drawings into a software application. This solution proves to be very time consuming and prone to data input errors such as discrepancies between original information and what is input. Finally, engineering consultants and/or facility operators can develop custom applications to extract information from the data source and bulk load that data into another application. This solution may result in duplicate storage of the information and therefore discrepancies when there are ongoing modifications made to the data. In many cases, the limitations of these conventional solutions mean that users often chose not to implement them.

Therefore, what is needed is a system and method for automating the extraction of information contained within engineering documents so that the components of a facility can be indexed.

### BRIEF SUMMARY OF THE INVENTION

In one embodiment of the invention, a method for component indexing of a design file is provided. The method includes the steps of extracting information about the components from the design file, linking the information to an entry in a data store, and importing the information into a data store. A further embodiment of the invention can include the steps of accessing the component information via a component hierarchical structure and/or determining which components in the design file can be indexed.

In another embodiment of the invention, a system for component indexing of design file is provided. The system includes an extraction engine for extracting information about the components of the design file, a data store for storing the information, and a link module operative to link each component with the design file. A further embodiment of the invention includes an analyzer for determining which components in the design file can be indexed and/or a browser for accessing the component information via a hierarchical structure.

In yet another embodiment of the invention, a machine-readable medium for component indexing of a design file is provided. The machine-readable medium includes instructions for enabling a processor to extract information about the components from the design file, link each component to the design file, and import the information into a data store. In a further embodiment, the machine-readable medium includes further instructions that enable the processor to access the component information via a component hierarchical structure and/or determine which components in the design file can be indexed.

In still a further embodiment, a method for obtaining and indexing data is provided. The method includes the steps of providing a file including at least one component that comports with a defined drafting standard, scanning the file to identify each component that comports with the drafting standard, inferring information regarding the identified component based on the drafting standard, and importing the information into a data store. Further embodiments can include the steps of comparing a symbol associated with the at least one component to the drafting standard, linking each component with the file in a component index table, importing the information into an instance table using a mapping file, performing a reverse lookup to determine if an associated class exists for the component, and generating an object representation of the associated class if the associated class exists.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is a flow diagram of an exemplary embodiment of a method according to the present invention; and

FIG. 2 depicts an exemplary embodiment of a system according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

Exemplary embodiments of the invention provide a method and system for seamless integration between document management and data centric solutions to ensure that the advantages of the two systems can be realized in a single environment. The system and method can be used throughout the life cycle of a facility or an asset—regardless of whether or not it is used in one or all phases—from conceptual design, through to detailed design, procurement, construction, operation, and maintenance.

The process of extracting information contained within an engineering document, and storing that information for re-use is automated. A means by which a user can then browse, search and display the extracted information, and provides links to the originating documents is also provided.

A representation of a facility or an asset—whether it is a building, process plant, roadway, map, utility, or the like can be created through a Computer Aided Design (CAD) program. The CAD program allows designers to create numerous drawings to represent the different aspects of a facility or asset. Typically, a designer understands what is represented in an engineering drawing simply by looking at it. The graphical elements in the drawing are displayed in such a way as to convey a particular meaning. For example, in an electrical diagram, a symbol, such as a square, may be used to represent a light switch, and a different symbol, such as a particular-size rectangle, may be used to represent a light fitting. Similarly, lines of different colors, thickness, or styles, can be used to represent and differentiate between different features in the drawing, for example, green lines may represent high voltage and yellow lines may represent low voltage power lines. The use of symbols, colors, and the like to represent real world objects is commonly referred to as drafting standards. When a drawing is created that adheres to a known set of drafting standards, valuable information can be inferred from the drawing simply by looking at it. Using the example drafting standards mentioned above, it can be inferred that a drawing including a square connected with a yellow line represents a light switch connected with a low voltage power line.

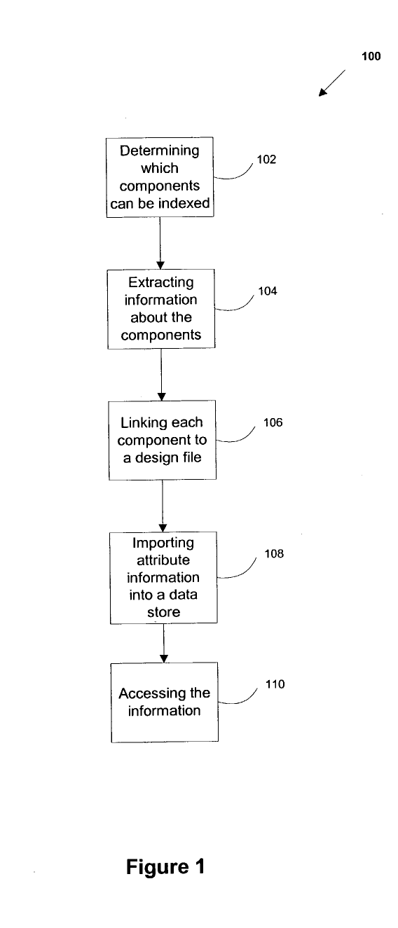

The concept of drafting standards can be used to infer information from engineering drawings that were not created using a data centric approach. Referring now to the drawings, flow diagram 100 of FIG. 1 illustrates an exemplary embodiment of the process for extracting and inferring information from a source file. The source file includes representations or symbology from which information about the items represented or symbolized can be inferred. The source file can be a 2-dimensional or 3-dimensional CAD file, a spreadsheet, or any other file or drawing from which information not included in the file can be inferred and/or extracted. Information about components can be stored in the source file according to a particular schema, that is, the way the data is stored. This schema does not have to be consistent with a schema used for indexing the components in a central data store.

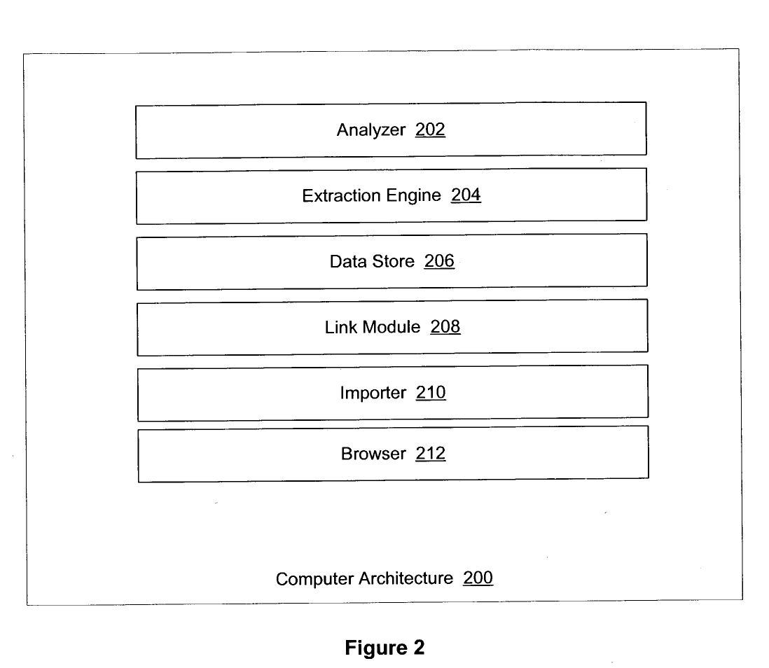

The process can begin with validation step 102. In validation step 102, analyzer 202 of computer architecture 200 (as shown in FIG. 2) can run processes to determine which components in the source file comport with a set of drafting standards and thus contain information that can be captured and/or indexed. This determination can be made using drafting standards. As described above, drafting standards refer to lines, shapes, symbols, etc. being used in such a way in a design file that a viewer of a graphical representation of a design file can look at the graphical representation and determine what is being represented. The drafting standards do not have to adhere to an industry-accepted set of drafting standards, such as, e.g., ANSI or DIN standards. Instead, the drafting standards need only be a consistent set of symbols. In other words, the drafting standards need only be defined by the user. The drafting standards are electronically defined and readable by a computer process.

By electronically defining the drafting standards used to create engineering drawings, analyzer 202 can run processes during validation step 102 that compare the elements, i.e., symbols, within an engineering drawing (the source file) to the drafting standards. Those symbols in the source file that match symbols in the drafting standards are identified. The electronically defined drafting standards can be stored in, for example, a settings file in a CAD program. The settings file can contain, among other things, a list of symbols and real world objects that are associated with each symbol. To compare the graphical elements with the drafting standards, analyzer 202 can search the source file for components that form a symbols. The analyzer 202 also searches the settings file to determine if the symbol found in the source file is present and defined in the settings file. For example, the symbol “S/V” that is represented in a particular Process and Instrumentation Diagram (P&ID) can be associated with a shut-off valve in the settings file. It should be noted that the text symbol “S/V” is being used for purposes of the discussion. In the engineering drawings, the symbol “S/V” can be a graphical symbol, (i.e., a pictorial representation) of a shut-off valve, rather than text. When an occurrence of symbol,

“S/V”, is found within a drawing and that symbol matches a symbol defined by the drafting standards, information can be inferred for that component, i.e., that a shut-off valve exists in the design file. Those components or symbols in the design file that do not have a match in the settings file do not conform to the drafting standards. Thus, that particular component cannot be indexed. Those components for which there is a match are further processed during extraction step 104.

When a graphical element or symbol in a source file is found to match the drafting standards, information about that component that is not contained with the source file can be inferred. That information often includes attribute information that is associated with the real world object represented in the source file. The attribute information can be captured during extraction step 104. During extraction step 104, a record or an object representation for the component can be created and/or updated for storage in the data store. Attribute information includes more detailed information regarding the real world object represented by the component. For example, information about the shut-off valve represented by the symbol “S/V” mentioned above may include the size of the shut-off valve, whether the valve is manual or automatic, the type of valve (e.g., ball, butterfly, check or control), and whether the valve is inline. The attribute information often provides valuable information that more fully describes a component and may also include, for example, an asset ID or description. The asset ID enables a user to differentiate between multiple occurrences of the same component type in a given design file(s). To differentiate between these multiple occurrences, each component must have a unique identifier.

Furthermore, the attribute information includes a unique identifier that is associated with the drawing that the specific component appears in. Storing a listing of all of the source files that a specific component appears in advantageously allows engineering consultants, facility operators, emergency personnel, or the like to quickly locate the documents (or source files) associated with a component, therefore saving time both in day-to-day operations and emergency situations.

To create an object representation of the component, extraction engine 204 performs a reverse lookup in the settings file to determine if an object-oriented class for a particular symbol exists within the settings file. Continuing with the example discussed above, when the “S/V” symbol is recognized as being a shut-off valve, a reverse lookup can be performed to determine which object oriented class is associated with a shut-off valve. For example, a search of the settings file can be performed to determine if there is an object oriented class “valve_shut_off.” If a class “valve_shut_off” is found, then an instance of the class “valve_shut_off” can be created for that particular component. If the class “valve_shut_off” is not found, a hierarchical search can be performed. The end of the file name is dropped and a search for the stem is performed. For example, the “shut_off” portion of the file name is dropped and a search for a class “valve” is performed. If the class “valve” is found, then an instance of the class “valve” can be created.

To capture the attribute information, the attribute information can be extracted from the source file for insertion into the variable fields of the instance once the instance has been created. Each class can have one variable for storing the unique identifier of the component. For example, if the unique identifier for the shut-off valve in the given example is SV101, that attribute can be stored in a variable valve_shut_off.id of class valve_shut_off. Additionally, the object representation also includes a variable for storing the unique identifier associated with the document in which the component is located. If a component is found in more than one document, another object representation need not be created. Instead, the attribute information can be updated to include the additional documents in a component index.

Depending on the application used to create the engineering drawing, the attribute information may be stored within the engineering drawing itself, or external to the graphical representation of the design file. In the event that the attribute information is stored external to the drawing, extraction step 104 can include a process for retrieving the attribute information from an external file.

In one exemplary embodiment, extraction step 104 may occur at a user defined event, such as, e.g., when a drawing is modified or when the workflow state changes from “in-progress” to “approved.” In another exemplary embodiment, the extraction step 104 may be launched manually. These alternate embodiments allow users to ensure that information is extracted from engineering drawings at a time that is appropriate to their work processes. Once attribute information about components are extracted during extraction step 104, the process can proceed to linking step 106.

During linking step 106, data relating to the document name (or filename) in which the component is located can be linked in a component index table by link module 208. The component index table can serve to map each component with all of the unique identifiers of the documents in which that component exists. For example, if shut-off valve SV101 exists in three P&Ids having unique identifiers pid1, pid2, and pid3, the component index table maps SV101 to pid1, pid2, and pid3.

During importing step 108, importer 210 can transfer the component information into data store 206. Data store 206 can be an instance table that stores the attributes for each instance created during extraction step 104. For example, the instance table can have rows that designate each instance that is created and columns for storing the attributes of each instance. As discussed above, attribute information may be extracted from a source file that does not have a data schema that is consistent with the schema for indexing components in data store 206. Where the two schemas are inconsistent, importer 210 can use a map file, such as, an XML file, to map the attributes in the data schema to the component indexing schema. Once the attribute information is linked and imported into data store 206, the information can be accessed during accessing step 110.

During accessing step 110, in one exemplary embodiment, a user can use browser 212 to browse through the component attribute information based on a component hierarchical structure. For example, if a user wants to locate shut-off valve SV101, the user can access the valve through a hierarchical structure that includes, for example all valves as the parent to shut-off valves. In such an exemplary embodiment, browser 212 can include an application that allows users to browse a directory tree structure that is based on the components. For example, the directory tree can include a folder labled “valves” that can include, among other things, subfolder labeled “shut-off valves.” If a user is looking for shut-off valve SV101, they could expand the “valve” folder and then browse through the “shut-off valve” subfolder to locate SV101.

In another exemplary embodiment, a user can browse through components within the drawing itself during accessing step 110. In such an embodiment, each graphical representation or symbol, can be linked, for example, in such a manner that the user can click on the graphical representation or symbol to view the attribute information. In such an embodiment, the symbol for the component can be linked such that a user can click on the graphical representation or symbol and view the attribute information. For example, if a user wants to view the attribute information for shut-off valve SV101, the user can click on the symbol “S/V” that represents shut-off valve SV101 and view the attribute information.

It should be noted that the several of the steps of flow diagram 100 are optional and can be carried out in any order without departing from the spirit of the invention.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method for indexing components of a design file, the method comprising the steps of:
extracting information about the components from the design file;
linking each component to the design file; and
importing the information into a data store.

2. The method of claim 1, wherein the extracting step includes creating an object representation of the information.

3. The method of claim 1, wherein the data store comprises a relational database, the relational database having a related instance tables.

4. The method of claim 3 wherein the instance tables include the information about each component.

5. The method of claim 1, wherein the design file is a two-dimensional design file.

6. The method of claim 1, wherein the design file is a three-dimensional design file.

7. The method of claim 1, further comprising the step of:
accessing the component information via a component hierarchical structure.

8. The method of claim 1, further comprising the step of:
determining which components in the design file can be indexed.

9. The method of claim 1, wherein the information includes a unique identifier for uniquely identifying each of the components.

10. A system for indexing the components of a design file, the system comprising:
an extraction engine for extracting information about the components of the design file;
a data store;
a link module operative to link each component with the design file; and
an importer for importing the information into the data store.

11. The system of claim 10, the extraction engine further comprising an object generation module, the object generation module being operative to create an object representation of the component.

12. The system of claim 10, wherein the data store is a relational database.

13. The system of claim 12, wherein the relational database is associated with a component index table.

14. The system of claim 13, wherein the component index table links each component with the design file.

15. The system of claim 13, wherein the relational database is associated with an instance table.

16. The system of claim 10, further comprising:
a browser for accessing the information about the components via a component hierarchical structure.

17. The system of claim 10, further comprising:
a analyzer for determining which components in the design file can be indexed.

18. The system claim 10, wherein the information includes a unique identifier for uniquely identifying each of the components.

19. A machine-readable medium for component indexing of a design file, the machine-readable medium comprising instructions that enable a processor to:
extract information about the components from the design file;
link each component to the design file; and
import the information into a data store.

20. The machine-readable medium of claim 19, further comprising instructions that enable a processor to:
access the information about the components via a component hierarchical structure.

21. The machine-readable medium of claim 19, further comprising instructions that enable a processor to:
determine which components in the design file can be indexed.

22. The machine-readable medium of claim 19, wherein the information includes a unique identifier for uniquely identifying each of the components.

23. A method for obtaining and indexing data, comprising:
providing a file including at least one component that comports with a defined drafting standard;
scanning the file to identify each component that comports with the drafting standard;
inferring information regarding the identified component based on the drafting standard; and
importing the information into a data store.

24. The method of claim 23, the scanning step further comprising:
comparing a symbol associated with the at least one component to the drafting standard.

25. The method of claim 23, the importing step further comprising:
linking the at least one component with the file in a component index table; and
importing the information into an instance table using a mapping file.

26. The method of claim 23, the inferring step further comprising:
performing a reverse lookup to determine if an associated class exists for the component; and
generating an object representation of the associated class if the associated class exists.
